(19) United States
(12) Patent Application Publication
(10) Pub. No.: US 2005/0157370 A1
(43) Pub. Date: Jul. 21, 2005

(54) Deformable mirror device (DMD) spatial light modulator (SLM) with dual counter-opposed deflection electrodes

(75) Inventor: Jiun-Nan Chen, Taipei (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/761,655

(22) Filed: Jan. 20, 2004

(51) Int. Cl. G02B 26/00

(52) U.S. Cl. 359/290

(57) ABSTRACT

A deformable mirror device spatial light modulator employs a pair of substrates each having formed therein a deflection electrode. The pair of deflection electrodes is separated by a gap having positioned therein a deformable mirror which is registered with both of the pair of deflection electrodes. Appropriate magnitudes and polarities of voltages are applied to the pair of deflection electrodes and the deformable mirror such as to deflect the deformable mirror with enhanced deflection control.

### BACKGROUND OF THE INVENTION

1. Field of the Invention

The present invention relates generally to spatial light modulators (SLMs). More particularly, the present invention relates to deformable mirror device (DMD) spatial light modulators with enhanced performance.

2. Description of the Related Art

Spatial light modulators are optical transducers that modulate optical properties of radiation beams incident thereupon. Such modulated optical properties may include, but are not limited to, phase, intensity, polarization and direction. Spatial light modulators find use in electronic devices such as high definition televisions (HDTVs), projectors and printers.

Of the various types of spatial light modulators, a generally common design is a deformable mirror device. Deformable mirror devices typically modulate a direction of an incident radiation beam by means of pivoting at least portions of an array of deformable (i.e., deflectable) mirrors such as to change an angle of reflection of the incident radiation beam with respect to the array of deformable mirrors.

While deformable mirror devices are thus common spatial light modulators, deformable mirror devices are nonetheless not entirely without problems. In that regard, it is often difficult to fabricate deformable mirror devices with enhanced performance, in particular as regards deformable mirror deflection control.

It is thus desirable within the spatial light modulator art to provide deformable mirror devices with enhanced performance. It is towards the foregoing object that the present invention is directed.

Various deformable mirror devices having desirable properties, and methods for fabrication thereof, have been disclosed in the spatial light modulator art.

Included among the deformable mirror devices and methods for fabrication thereof, but not limiting among the deformable mirror devices and methods for fabrication thereof, are deformable mirror devices and methods for fabrication thereof disclosed within: (1) Hornbeck, in U.S. Pat. No. 5,018,256 (a single substrate deformable mirror device with enhanced fabrication yeild); and (2) Huibers, in U.S. Pat. No. 6,356,378 (a dual substrate deformable mirror device with a deformable mirror deflection stop component) . The teachings of both of the foregoing references are incorporated herein fully by reference.

Desirable within the spatial light modulator art are additional deformable mirror devices with enhanced performance.

It is towards the foregoing object that the present invention is directed.

### SUMMARY OF THE INVENTION

A first object of the invention is to provide a deformable mirror device.

A second object of the invention is to provide a deformable mirror device in accord with the first object of the invention, wherein the deformable mirror device is fabricated with enhanced performance.

In accord with the objects of the invention, the invention provides a deformable mirror device, a method for fabrication thereof and a method for operation thereof.

In accord with the invention, the deformable mirror device comprises a first substrate having a first surface. The deformable mirror device also comprises a first deflection electrode formed at least partially on the first surface of the first substrate. The deformable mirror device also comprises a deflectable element connected to the first surface of the first substrate and registered with the first deflection electrode. The deformable mirror device also comprises a second substrate assembled and spaced opposite the first surface of the first substrate, where the second substrate has formed therein a second deflection electrode registered with the deflectable element.

The deformable mirror device of the invention contemplates: (1) a sub-assembly laminating method for forming the deformable mirror device; and (2) a method for operating the deformable mirror device by employing appropriate magnitudes and polarities of voltages applied to the first deflection electrode, the second deflection electrode and the deformable mirror.

The invention provides a deformable mirror device, wherein the deformable mirror device is fabricated with enhanced performance.

The present invention realizes the foregoing object by employing within a deformable mirror device a deformable mirror which is positioned interposed between and separated from each of a pair of deflection electrodes such that deflection of the deformable mirror may be more readily controlled by independently applying a voltage of appropriate polarity and magnitude to each of the pair of deflection electrodes and the deformable mirror.

### BRIEF DESCRIPTION OF THE DRAWINGS

The objects, features and advantages of the invention are understood within the context of the Description of the Preferred Embodiments, as set forth below. The Description of the Preferred Embodiments is understood within the context of the accompanying drawings, which form a material part of this disclosure, wherein:

FIG. 1, FIG. 2, FIG. 3 and FIG. 4 show a series of schematic cross-sectional diagrams illustrating the results of progressive stages of forming and operating a deformable mirror device in accord with a first preferred embodiment of the invention.

FIG. 5 and FIG. 6 show a pair of schematic cross-sectional diagrams illustrating the results of progressive stages of operating a deformable mirror device in accord with a second preferred embodiment of the invention.

### DESCRIPTION OF THE PREFERRED EMBODIMENTS

The present invention provides a deformable mirror device, wherein the deformable mirror device is fabricated with enhanced performance.

The present invention realizes the foregoing object by employing within a deformable mirror device a deformable mirror which is positioned interposed between and separated from each of a pair of deflection electrodes such that deflection of the deformable mirror may be more readily controlled by independently applying a voltage of appropriate polarity and magnitude to each of the pair of deflection electrodes and the deformable mirror.

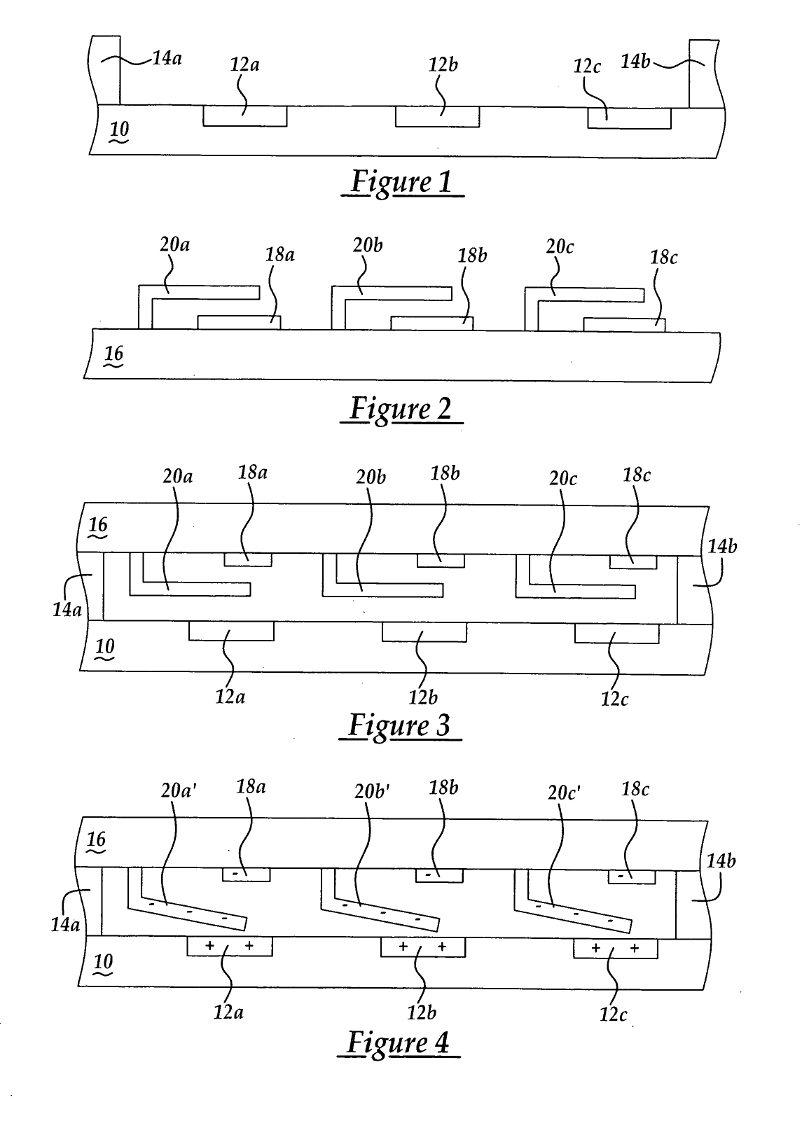

FIG. 1 to FIG. 4 show a series of schematic cross-sectional diagrams illustrating the results of progressive stages of forming and operating a deformable mirror device in accord with a first preferred embodiment of the invention.

FIG. 1 and FIG. 2 show a pair of component sub-assemblies which are assembled to provide the deformable mirror device.

FIG. 1 shows a first substrate 10 having formed therein a series of first deflection electrodes 12a, 12b and 12c. FIG. 1 also illustrates a pair of spacer layers 14a and 14b formed upon the first substrate 10 and spaced from the series of first deflection electrodes 12a, 12b and 12c.

Within the invention, the first substrate 10 is typically a semiconductor substrate, although other substrates, such as but not limited to conductor substrates and dielectric substrates, are not precluded within the invention.

Within the invention when the substrate 10 is a semiconductor substrate, the series of first deflection electrodes 12a, 12b and 12c may be formed as a series of doped regions within the semiconductor substrate 10. In the alternative, the series of first deflection electrodes 12a, 12b and 12c may be formed as a series of patterned conductor layers formed upon the substrate 10, when the substrate is selected from the group including but not limited to conductor substrates, semiconductor substrates and dielectric substrates. Typically each of the series of first deflection electrodes 12a, 12b and 12c is defined within a pixel cell of bidirectional (i.e., areal) pixel cell width of from about 10 to about 20 microns. Thus, although not specifically illustrated within the schematic cross-sectional diagram of FIG. 1, the series of first deflection electrodes 12a, 12b and 12c is intended as representative of a planar bi-directional array of deflection electrodes.

Within the invention, the pair of spacer layers 14a and 14b is intended to facilitate formation of a gap above the series of first deflection electrodes 12a, 12b and 12c incident to further assembly of the first substrate 10 as illustrated within FIG. 1. Although under certain circumstances the pair of spacer layers 14a and 14b may be formed from any of several spacer materials, including but not limited to conductor spacer materials, semiconductor spacer materials and dielectric spacer materials, the pair of spacer layers 14a and 14b is typically formed of a dielectric spacer material. More typically, the pair of spacer layers 14a and 14b is formed from a photoexposed and developed photoresist dielectric spacer material. Typically, each of the pair of spacer layers 14a and 14b is formed to a thickness of from about 5 to about 10 microns.

FIG. 2 shows a transparent second substrate 16, which is intended as transparent to a beam of radiation intended to be modulated by a deformable mirror device spatial light modulator in accord with the invention. As is illustrated in FIG. 2, the second substrate 16 has formed thereupon a series of second deflection electrodes 18a, 18b and 18c. The second substrate 16 also has formed thereupon a series of deformable mirror structures 20a, 20b and 20c.

Within the invention, the second substrate 16 is typically a glass substrate or a quartz substrate for purposes of modulation of an incident optical radiation beam. Other substrates as are known transparent may be employed for modulation of radiation beams other than optical radiation beams.

Within the invention, the series of second deflection electrodes 18a, 18b and 18c may be formed of electrode materials analogous or equivalent to the electrode materials from which are formed the series of first deflection electrodes 12a, 12b and 12c under circumstances where the series of second deflection electrodes 18a, 18b and 18c is intended to occlude and shadow a portion of the series of deformable mirror structures 20a, 20b and 20c. Alternatively, the series of second deflection electrodes 20a, 20b and 20c may be formed of a transparent electrode material, such as but not limited to an indium-tin oxide transparent electrode material. Typically, each of the series of second deflection electrodes 20a, 20b and 20c is formed to a thickness of from about 0.5 to about 1.5 microns.

Within the invention the deformable mirror structures 20a, 20b and 20c are typically formed as a series of support posts having laminated thereto a series of reflective mirror beams, as illustrated in FIG. 2. Typically, the support posts are formed to a thickness of from about 2 to about 3 microns and the reflective mirror beams are formed to a thickness of from about 0.5 to about 1.5 microns.

In order to fabricate the sub-assembly of FIG. 2, the series of second deflection electrodes 18a, 18b and 18c is first formed upon the second substrate 16. The second substrate 16 and the series of second deflection electrodes 18a, 18b and 18c is then overcoated with a sacrificial planarizing photoresist spacer material layer which is patterned to form vias into which are formed the support posts. The reflective mirror beams are then laminated to exposed portions of the support posts and the sacrificial planarizing photoresist spacer material layer, and the sacrificial planarizing photoresist spacer material layer is etched to leave remaining the free standing deformable mirror structures 20a, 20b and 20c.

Although each of the series of deformable mirror structures 20a, 20b and 20c is illustrated in FIG. 2 as formed in an “L” shape, when formed employing other methods deformable mirror structures of other shapes may also be employed within the present invention.

FIG. 3 shows the results of further assembly of the deformable mirror device sub-assemblies of FIG. 1 and FIG. 2.

FIG. 3 shows the results of laminating and mating the first substrate 10 as illustrated in FIG. 1 with the second substrate 16 as illustrated in FIG. 2 to provide a deformable mirror device spatial light modulator in accord with a first preferred embodiment of the invention. Within the deformable mirror device spatial light modulator, each of the first deflection electrodes 12a, 12b and 12c is registered with a corresponding second deflection electrode 18a, 18b or 18c, but separated therefrom by a gap defined in thickness in part by the pair of spacers 14a and 14b. In addition, interposed between corresponding pairs of the first deflection electrodes 12a, 12b and 12c and the second deflection electrodes 18a, 18b and 18c is the corresponding deformable mirror portion of the deformable mirror structures 20a, 20b and 20c which are also registered with the series of first deflection electrodes 12a, 12b and 12c and the series of second deflection electrodes 18a, 18b and 18c. Within the context of the invention “registered” is intended as meaning that the first deflection electrodes 12a, 12b and 12c and the second deflection electrodes 18a, 18b and 18c are positioned with respect to each other and the series of deformable mirror structures 20a, 20b and 20c such as to enable (upon proper charging) electrical field influence of the series of first deflection electrodes 12a, 12b and 12c and the series of second deflection electrodes 18a, 18b and 18c upon the reflective mirror portions of the series of reflective mirror structures 20a, 20b and 20c.

FIG. 4 shows the results of operation of the deformable mirror device spatial light modulator of FIG. 3.

FIG. 4 shows the results of imposing voltages of opposite polarity upon the series of first deflection electrodes 12a, 12b and 12c with respect to the series of second deflection electrodes 18a, 18b and 18c, while simultaneously imposing upon the series of deformable mirrors within the series of deformable mirror structures 20a, 20b and 20c a voltage of polarity the same as the series of second deflection electrodes 18a, 18b and 18c. The foregoing voltages are of a magnitude such as to deflect the series of deformable mirrors within the series of deformable mirror structures 20a, 20b and 20c in the direction of the series of first deflection electrodes 12a, 12b and 12c and form therefrom a series of deformed deformable mirror structures 20a′, 20b′ and 20c′. Typically operating voltages for the series of first deflection electrodes 12a, 12b and 12c, the series of second deflection electrodes 18a, 18b and 18c and the series of deformable mirrors range up to about +/−6 volts. Appropriate electrical connections and addressing of the series of first deflection electrodes 12a, 12b and 12c, the series of second deflection electrodes 18a, 18b and 18c and the series of deformable mirror structures 20a, 20b and 20c is provided employing conductor structures which are not otherwise specifically illustrated within FIG. 1, FIG. 2, FIG. 3 or FIG. 4.

Within the invention, the use of both the series of first deflection electrodes 12a, 12b and 12c and the series of second deflection electrodes 18a, 18b and 18c for purposes of positioning and deflecting the series of deformable mirrors provides enhanced deformable mirror deflection control and thus enhanced performance of the deformable mirror device spatial light modulator of the invention.

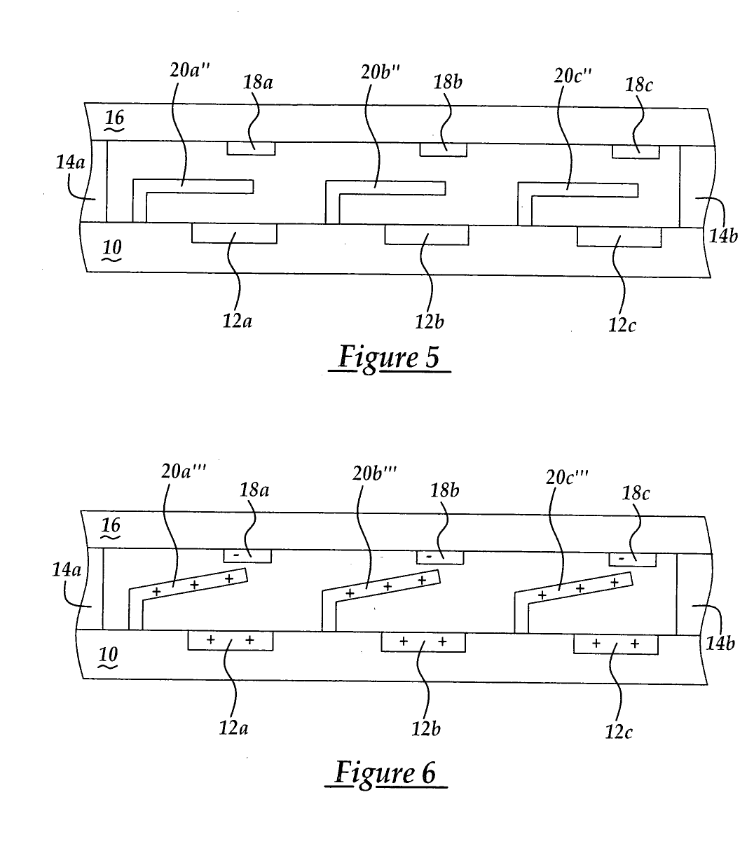

FIG. 5 illustrates a deformable mirror device spatial light modulator in accord with an alternate preferred embodiment of the invention which provides a second preferred embodiment of the invention.

FIG. 5 corresponds generally with FIG. 3, but the series of deformable mirror structures 20a, 20b and 20c as formed upon the second substrate 16 as illustrated within FIG. 3 are instead formed as a series of inverted deformable mirror structures 20a″, 20b″ and 20c″ formed upon the first substrate 10. Materials of fabrication and dimensions of the deformable mirror device spatial light modulator of the second preferred embodiment of the invention are otherwise analogous, equivalent or identical to those of the first preferred embodiment of the invention.

FIG. 6 show a schematic cross-sectional diagram illustrating operation of the deformable mirror device spatial light modulator of FIG. 5.

FIG. 6 is generally analogous to FIG. 4 and also illustrates a deflection of a series of deformable mirrors when forming a series of deflected inverted deformable mirror structures 20a′″, 20b′″ and 20c′″ from the series of inverted deformable mirror structures 20a″, 20b″ and 20c″.

As is illustrated within FIG. 4 and FIG. 6, deformable mirrors may be deflected either upward or downward (i.e., towards either series of deflection electrodes) within the gap defined between the series first deflection electrodes 12a, 12b and 12c and the series of second deflection electrodes 18a, 18b and 18c. As is understood by a person skilled in the art, alternative polarities of voltages may also effect the same result as illustrated within FIG. 4 and FIG. 6.

FIG. 3, FIG. 4, FIG. 5 and FIG. 6 illustrate fabrication and operation of a pair of deformable mirror device spatial light modulators in accord with the preferred embodiments of the invention. The pair of deformable mirror device spatial light modulators provides enhanced performance in particular with respect to enhanced deformable mirror deflection control. The enhanced deformable mirror deflection control is effected by employing a pair of deflection electrodes one each located on opposite sides of a deformable mirror.

The preferred embodiments of the invention are illustrative of the invention rather than limiting of the invention. Revisions and modifications may be made to materials, structures and dimensions in accord with the preferred embodiments of the invention while still providing a deformable mirror device spatial light modulator in accord with the invention, a method for fabrication thereof and a method for operation thereof, further in accord with the accompanying claims.

1-3. (canceled)

4. A cell structure for a spatial light modulator comprising:
a first substrate having a first surface;
a plurality of first deflection electrodes formed at least partially on the first surface of the first substrate;
a plurality of deflectable elements supported at only one end thereof and connected to the first surface of the first substrate and registered with the plurality of first deflection electrodes;
a second substrate assembled and spaced opposite the first surface of the first substrate, the second substrate having formed therein a plurality of second deflection electrodes registered singly with the plurality of deflectable elements and the plurality of first deflection electrodes such that a deflectable element is physically constrained between a first deflection electrode and a second deflection electrode.

5. The cell structure of claim 4 wherein the first deflection electrode and the deflectable element are of the same polarity of charge and the deflectable element is deflected away from the first deflection electrode.

6. The cell structure of claim 4 wherein the first deflection electrode and the deflectable element are of opposite polarity of charge and the deflectable element is deflected towards the first deflection electrode.

7. The cell structure of claim 4 wherein the first substrate is a transparent substrate.

8. The cell structure of claim 7 wherein the first deflection electrode is a transparent electrode.

9. The cell structure of claim 4 wherein the second substrate is a transparent substrate.

10. The cell structure of claim 9 wherein the second deflection electrode is a transparent electrode.

11. A method for fabricating a deformable mirror device comprising: providing:
a first substrate having formed therein a plurality of first deflection electrodes;
a second substrate having formed therein a plurality of second deflection electrodes, where one of the first substrate and the second substrate has formed thereupon a plurality of deformable mirror structures each supported on only one end thereof; and
assembling the first substrate to and spaced from the second substrate such that:
each of the plurality of first deflection electrodes is singly registered with and separated from each of the plurality of second deflection electrodes; and
each of a plurality of deformable mirrors within the plurality of deformable mirror structures is interposed between, physically constrained between, registered with and separated from a singly registered pair of a both the first deflection electrode and the a second deflection electrode.

12. The method of claim 11 wherein the deformable mirror structure is formed upon the first substrate.

13. The method of claim 11 wherein the deformable mirror structure is formed upon the transparent second substrate.

14. The method of claim 11 wherein the second deflection electrode is a transparent electrode.

15. A method for operating a deformable mirror device comprising:
providing a deformable mirror device comprising:
a first substrate having formed therein a plurality of first deflection electrodes;
a second transparent substrate having formed therein a plurality of second deflection electrodes, the first substrate being assembled to and separated from the second substrate such that each of the plurality of first deflection electrodes is registered with and separated from each of the second deflection electrodes to form singly mated pairs of first deflection electrodes and second deflection electrodes; and
a plurality of deformable mirror structures formed upon one of the first substrate and the second substrate, each deformable mirror within a plurality of deformable mirrors within the plurality of deformable mirror structures being interposed between, physically constrained between registered with and separated from both of a mated pair of a first deflection electrode and a second deflection electrode, each deformable mirror being supported on only one end thereof; and
imposing upon the first deflection electrode, the second deflection electrode and the deformable mirror a series of voltages of polarity and magnitude such as to deform the deformable mirror towards the first deflection electrode or the second deflection electrode.

16. The method of claim 15 wherein the deformable mirror structure is formed upon the first substrate.

17. The method of claim 15 wherein the deformable mirror structure is formed upon the transparent second substrate.

18. The method of claim 15 wherein the second electrode is a transparent electrode.

19. The method of claim 15 wherein the deformable mirror is deformed towards the first electrode.

20. The method of claim 15 wherein the deformable mirror is deformed towards the second electrode.

21. The cell structure of claim 4 wherein each of the first deflection electrode and the second deflection electrode serves as a stop with respect to the deflectable element.

22. The method of claim 11 wherein each of the first deflection electrode and the second deflection electrode serves as a stop with respect to a deformable mirror.

23. The method of claim 15 wherein each of the first deflection electrode and the second deflection electrode serves as a stop with respect to the deformable mirror.
